(19) United States
(12) Patent Application Publication
(10) Pub. No.: US 2024/0375872 A1
(43) Pub. Date: Nov. 14, 2024

(54) SYSTEM FOR SINGULATING AND IDENTIFYING ARTICLES

(71) Applicant: Knapp AG, Hart bei Graz (AT)

(72) Inventors: Franz MATHI, Hart bei Graz (AT); Marc PENDL, Hart bei Graz (AT); Florian KRASNITZER, Hart bei Graz (AT); Wolfgang PUNTIGAM, Hart bei Graz (AT); Erich EICHER, Hart bei Graz (AT)

(21) Appl. No.: 18/689,212

(22) PCT Filed: Aug. 2, 2022
(86) PCT No.: PCT/AT2022/060270

§ 371 Date: Mar. 5, 2024

(30) Foreign Application Priority Data
Sep. 7, 2021 (AT) A 50707/2021

(51) Int. Cl. B65G 1/137; B65G 47/90

(52) U.S. Cl. CPC B65G 1/1371; B65G 47/90; B65G 2203/0216; B65G 2203/0225; B65G 2203/0233

(57) ABSTRACT

A system for singulating and identifying articles comprises a handling unit for transporting articles from a source position to a target position, a first sensor unit to detect the article position and/or orientation at the source position, a second sensor unit to register article identification of the article, and a control unit. The control unit registers gripping parameters such as a gripping position or a gripping surface based on the position and orientation of the article at the source position, selects a gripping method/tool, controls a handling unit to pick up and transport the article to a reading position to the reading position of the second sensor unit. The reading position is above the source position, and the control unit, upon successful identification, directs the handling unit to discharge the article to the target position.

The invention relates to a system for singulating and identifying articles, comprising: a source position for providing articles, preferably in source charge carriers, a target position for picking up singulated and identified articles, preferably in target charge carriers, a handling unit for picking up respectively one article from the source position and transporting and discharging the article to the target position, a first sensor unit configured to detect the position and/or orientation of the articles at the source position, a second sensor unit configured to register identification information of the article picked up by the handling unit at a reading position, and a control unit for controlling the handling unit, which is connected to the first and second sensor units, wherein the control unit is configured to determine a gripping position or gripping surface for the handling unit based on the position and/or orientation of the articles at the source position, select a gripping method and/or gripping tool for the handling unit, control the handling unit to pick up an article with the selected gripping method and/or gripping tool, and control the handling unit to move the article picked up to the reading position of the second sensor unit.

### PRIOR ART

It has been known that articles are stored or transported in source containers and are to be singulated at a later point in time, for example, to transfer a specific number of articles into a target container for shipping or similar purposes. In order to automate this process, handling units, i.e. robots having gripping functions, are used to pick up individual articles from the source containers for singulation. There have been known in particular the methods described in the following for the clear identification of the articles picked up.

EP 2477914 B1 discloses a system and a method for singulating and picking articles. Articles delivered on a first transport device are registered in position by a first sensor and transferred to a second transport device using a handling device, wherein the article is passed by a registration device during the transfer for identification. Unidentifiable articles are placed on a storage zone, picked up again in a different position, and again passed by the registration device for identification.

A particular drawback is the limited speed of the handling device, as an unidentifiable article occupies the handling device for a relatively long period of time. Throughput rates of only a few hundred articles per hour may be achieved, in particular when articles need to be passed through the storage zone.

From U.S. Pat. No. 10,438,034 B2 there has been known a system, in which products are individually dropped by a detection device for identification from a first delivering conveyor system. The products are then caught by a primary transport system and transported in parallel to the delivering conveyor system in the opposite direction to an ejection point, where unidentified products are ejected back towards the delivering conveyor system to be fed back to the detection device. A similar solution is also used by the company Soft Robotics.

Here, too, it has proven disadvantageous that articles that are not identifiable by the identification device for various reasons, blocking the system. For example, articles circulate endlessly in the system repeatedly unsuccessfully due to a damaged or unlocatable barcode. As the unidentifiable products are always mixed into the delivering product stream, the throughput rate of successfully identified products decreases reciprocally with the circulating unidentifiable products. The product supply has to be interrupted at regular intervals, and the circulating products must be removed from the system.

At the same time, the mixing of unidentifiable products with newly delivered products is a problem, as the new products are already assigned to a different product type or batch, respectively, and are mixed with circulating products from the previous product type or batch, respectively. In the field of picking, it is also disadvantageous that order goals have to wait indefinitely for circulating unidentifiable products.

### DISCLOSURE OF THE INVENTION

The present invention has therefore set the task of improving a system for singulating and identifying articles of the type initially mentioned in such a way that identification can be carried out in a more reliable and faster way and a system having higher throughput rates may be provided.

The invention solves the set task of the invention by the reading position of the second sensor unit being arranged above the source position and the control unit further being configured to identify the article picked up based on the identification information and, after successful identification, to control the handling unit to discharge the article to the target position.

If the reading position of the second sensor unit is arranged above, especially vertically above, the source position, the article picked up by the handling unit may directly fall back to the source position, in particular into the source container. This is particularly advantageous when an article was not fully and securely gripped by the handling unit and thus falls out of the gripping tool during movement of the handling unit. In addition, this may be particularly advantageous if the article cannot be identified at the reading position after determination of the identification information by the second sensor unit. This may be the case, for example, if the identification information to be read is located exactly on the gripping surface of the handling unit or is at least in part covered by it. In this case, the article may simply be dropped again by the handling unit and fall back to the source position, in particular into the source container. By falling back into the source container, the orientation of the article at the source position will change, so that when the article is picked up again, the identification information is no longer in the area of the gripping surface of the handling unit and can therefore be determined by the second sensor unit.

If the control unit is further configured to identify the article picked up based on the identification information and, after successful identification, control the handling unit to discharge the article to the target position, the identification of the article may already be ensured directly above the source position at the reading position, and in the case of non-identifiability of the article, this can simply fall back to the source position. This eliminates the need for technically complex and slow relocations and identification stations, at which the article is first placed and only picked up again by the handling unit after successful identification. The identification of the articles can thus be carried out much faster and more efficiently, increasing the throughput of the system.

In the context of the invention, as identification information is designated all types of information that may be used to identify an article. These may be article codes such as EAN codes or the like, batch numbers, or internal article references, as well as dimensions or optical prints. The identification information may be given in the form of barcodes, QR codes, numerical sequences, character strings, or the like, especially in machine-readable form, attached to the article.

In one embodiment of the invention, the control unit may be further configured to control the handling unit to return the article to the source position in the event of non-identifiability of the article at the reading position. The return may preferably be carried out in such a way that the article ends up in a different position at the source position than it was picked up. This may be achieved, for example, by the handling unit tilting or rotating the article when returning it so that it tips over to one side when placed back. Another article is then preferably retrieved from the source in the next step.

In another embodiment of the invention, the first sensor unit may be further configured to register identification information in the area of the gripping position or gripping surface of the article. This allows identification information in the area of the future gripping position or gripping surface, respectively, to be registered during the registration of the position and/or orientation of the article. This way, in cases where identification of the article by the second sensor unit at the reading position fails because the identification information is covered by the gripping tool of the handling unit, for example, this may be realized already in advance. The return of the article to the source position may thus be avoided, further increasing the efficiency of the system.

In a particularly advantageous embodiment of the invention, the system may have a third sensor unit that is configured to register identification information in the area of the gripping position or gripping surface of the article. The independent third sensor unit enables the registration of identification information in the area of the gripping position or gripping surface, respectively, in a technically simple manner. In particular, a camera having suitable resolution and optics may be used, allowing reliable registration of the identification information in the area of the gripping position or gripping surface, respectively. The identification information of the respective articles may preferably be registered directly without pre-positioning or alignment of the articles at the source position. In this way, as mentioned earlier, identification of the articles in cases where identification at the reading position by the second sensor unit fails, may thus be realized in advance, thus avoiding further handling of the articles. Furthermore, after prior identification, the article does not need to be provided at the reading position and may be directly transported to the target position, whereby the throughput of the system may be further increased.

In another advantageous embodiment, the third sensor unit may be provided on the handling unit and preferably alignable to register the identification information at the gripping position or gripping surface, respectively. The third sensor unit may advantageously be carried with the handling device and always aligned with the respective articles for registering the identification information in the area of the gripping position or gripping surface, respectively. The control unit may be further configured to position the handling unit with the third sensor device above the article in a way that allows complete registration of the identification information by the third sensor device.

According to a preferred embodiment, the control unit may also be configured to register identification information in the area of the gripping position or gripping surface, respectively, of the article using the third sensor unit after determining a gripping position or gripping surface for the handling unit and before picking up the article, and to identify the article based on the identification information. In particular when the identification information is located in the area of the gripping position or gripping surface, respectively, and would be at least partially covered during pickup by the gripping tool, identifying the article before it being picked up may contribute to avoiding further delays. This may prevent, for example, the article from having to be returned or thrown back, respectively, to the source position after pickup by the handling unit because the identification information at the reading position could not be registered by the second sensor unit or the article could not be identified in this way, respectively.

In particular, according to one embodiment variant, the control unit may be configured to determine a distance based on the position and/or orientation of the articles at the source position for the third sensor unit and to restrict the field of view of the sensor unit to an evaluation area that corresponds to the article to be gripped at the gripping position or gripping surface. This may be particularly advantageous when the third sensor unit is configured as a camera having a lens. A fixed focal length lens may be used as the lens, such that the field of view for registration of the identification information may be adjusted by adjusting the distance between the third sensor unit and the article. This makes it possible to achieve a particularly fast registration of the identification information. In an alternative embodiment variant, there may also be used a lens with variable focal length. Furthermore, the control unit may be configured to control the handling unit to adjust the determined distance between the third sensor unit and the article.

According to another embodiment variant, the control unit may be configured to assign the position and/or orientation of the articles registered by the first sensor unit to the identification information of the articles registered by the third sensor unit. Through this assignment, the control unit may already have a list of fully identified articles including their position and/or orientation at the source position already before picking up an article. Particularly preferred, the control unit may then, if possible, select an article from the already identified articles for pickup by the handling unit, thereby avoiding further registration of identification information at the reading position. In this way, the efficiency of the system may be significantly improved system.

In another embodiment variant, the control unit may be further configured to control the handling unit to directly discharge the identified article to the target position after picking up an identified article. Thus, an article that has already been successfully identified before being picked up by the handling unit may be discharged directly to the target position without being moved to the reading position for the second sensor unit. The successful identification of the article may have occurred as described earlier, for example, by registration of identification information in the area of the gripping position or gripping surface, respectively, by the third sensor unit directly at the source position and by identification thereof using the control unit. Alternatively, identification of the article may have also occurred by registration of identification information directly by the first sensor unit together with the position and/or orientation of the article and identification thereof using the control unit.

### BRIEF DESCRIPTION OF THE FIGURES

In the following, preferred embodiment variants of the invention are described in more detail with reference to the figures, wherein:

FIG. 1 shows a schematic view of the system according to a first embodiment variant of the invention in a first state,

FIG. 2 shows a schematic view of the system from FIG. 1 in a second state,

FIG. 3 shows a schematic view of the system from FIG. 1 in a third state,

FIG. 4 shows a schematic view of the system according to a second embodiment variant of the invention in a first state, and

FIG. 5 shows a schematic view of the system from FIG. 4 in a second state.

### WAYS FOR CARRYING OUT THE INVENTION

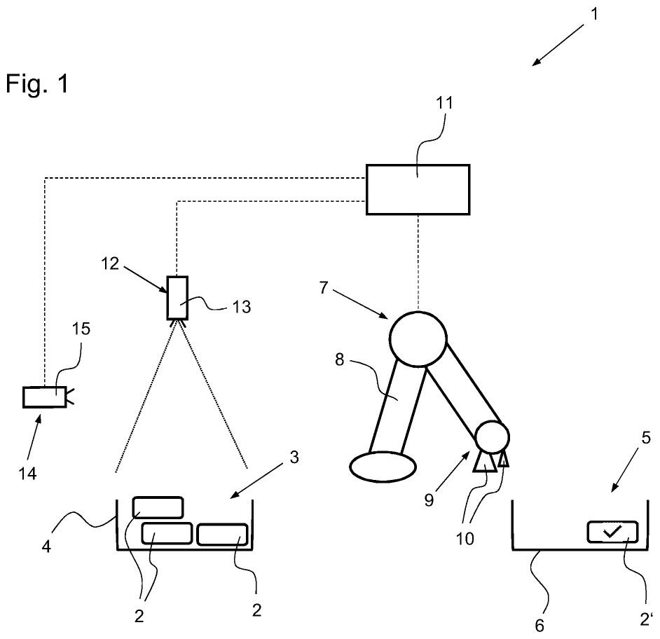

FIG. 1 shows a schematic representation of the system 1 according to the invention for singulating and identifying articles 2 according to a first embodiment variant of the invention. The articles 2 are provided at a source position 3 of the system, wherein the articles 2, however, are not identified at the source position 3. The aim is to transport articles 2 from the source position 3 to a target position 5 of the system and have them clearly identified and singulated there. The identification and singulation of the articles 2 may, for example, be carried out according to a specific order, wherein a specific number of predefined articles 2 are to be transported from the source position 3 to the target position 5. However, at the source position 3, articles 2 of multiple types may be present in any quantity, which is why an identification of the articles and, for example, a comparison of the articles with the order are necessary before transporting the articles 2 to the target position 5.

The system 1 comprises the source position 3, at which articles 2 may be provided, which—as shown in FIG. 1—are configured as source charge carriers 4. Such a source charge carrier 4 may preferably be configured as a storage container or the like.

According to another embodiment, the source position 3 may also be located on a conveyor system, wherein the articles 2 are provided, for example, on a conveyor belt or the like. Alternatively, the articles 2 may also be provided in a source charge carrier 4 on a container conveyor system, which is not further illustrated, however, in the figures.

The system 1 further comprises a target position 5 for picking up the singulated and identified articles 2′ from the source position 3. The singulated and identified articles 2′ are then picked up at the target position 5 in target charge carriers 6. The target charge carriers 6 have a similar configuration to the source charge carriers 4 as previously described: the target charge carriers 6 may preferably be configured as order containers containing all identified and singulated articles 2′ belonging to a specific order.

In an alternative embodiment variant that is not further illustrated in the figures, the target position 5 may also be located on an outgoing conveyor system, such as a conveyor belt. Alternatively, the target charge carriers 6 may also be provided on an outgoing container conveyor system to pick up the singulated and identified articles 2′.

In order to transport the articles 2 from the source position 3 to the target position 5, the system 1 further has a handling unit 7. The handling unit 7 may preferably be configured as a robotic arm 8, which has a variety of different gripping tools 9 that can be exchanged or selected, respectively, depending on the requirements and the article 2 to be picked up. As shown in FIG. 1, the gripping tool 9 has multiple suction grippers 10, which can grip the article 2 by suction, thus gripping it. In alternative embodiment variants, the gripping tool 9 may also be configured as a tong gripper, finger gripper, or the like. Other gripping systems are also conceivable, such as mechanical, pneumatic, magnetic, or adhesive gripping systems, which are not shown in detail in the figures.

The system 1 further comprises a first sensor unit 12, which is configured to detect the position and/or orientation of the articles 2 at the source position 3. The first sensor unit 12 may preferably be configured as a 3D camera 13, which can record a spatial image of the position and orientation of the articles 2 at the source position 3. In an alternative embodiment variant, the first sensor unit 12 may also be configured, for example, as a simple camera.

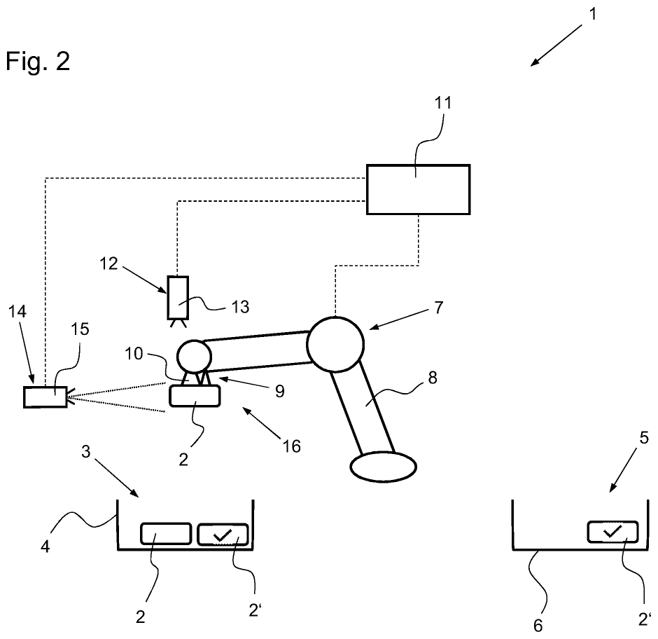

Furthermore, the system 1 comprises a second sensor unit 14, which is configured to register identification information of an article 2. The second sensor unit 14 is particularly arranged to register the identification information of an article 2 picked up by the handling unit 7 and provided by the handling unit 7 at a reading position 16. The provision of an article 2 at the reading position 16 is depicted in detail in FIG. 2 and described further below.

In a further embodiment variant, which is not shown in the figures, the second sensor unit 14 may also be formed by a sensor array, wherein the sensors in the sensor array are arranged linearly, in a ring shape, or in a matrix shape, for example.

In the system 1 there may further be provided a control unit 11, which is connected to the first sensor unit 12 and the second sensor unit 14 for the exchange of registered information or data, respectively. Thus, the first sensor unit 12 may transfer the registered position and/or orientation of the articles 2 at the source position 3 to the control unit 11, while the second sensor unit 14 may transfer the registered identification information of an article 2 picked up by the handling unit 7 to the control unit 11.

As shown in FIG. 1, the control unit 11 is further connected to the handling unit 7 to issue commands to it or to control it, respectively. The control unit 11 is specifically configured to determine a gripping position or gripping surface for the handling unit 7 based on the position and/or orientation of the articles 2 at the source position 3 and to select a suitable gripping method and/or gripping tool 9 for the handling unit 7. By selecting a gripping position or gripping surface, respectively, on the article 2 and a suitable gripping method or gripping tool, respectively, 9 for gripping the article 2 at the selected gripping position or gripping surface, respectively, there may be ensured that the article 2 can be reliably picked up by the handling unit 7.

Subsequently, the control unit 11 is then configured to control the handling unit 7 to pick up a selected article 2 with the selected gripping method or with the selected gripping tool 9 at the gripping position or gripping surface, respectively, and to control the handling unit 7 to move the article picked up 2 to the reading position 16 of the second sensor unit 15.

Finally, the control unit 11 is configured to control the handling unit 7 to discharge the article 2 to the target position 5 in case of a successful identification of the article 2 at the reading position 16.

FIG. 1 shows the system 1 in an initial state, wherein the first sensor unit 12 registers the position and/or orientation of the articles 2 and the handling unit 7 is in a rest or standby state, respectively.

After the position and/or orientation of the articles 2 have been registered, the control unit 11 controls the handling unit to pick up a selected article 2 and to provide the article 2 at the reading position 16.

As shown in FIG. 2, subsequently, the identification information of the article 2 provided by the handling unit 7 at the reading position 16 is registered by the second sensor unit 14. For this purpose, the article 2 picked up may be freely rotated by 360° by the handling unit 7 such that registration of the identification information may be carried out on all sides of the article 2. The second sensor unit 14 then transmits the registered identification information to the control unit 11, which in turn performs an identification of the article 2 based on this information.

In an alternative embodiment variant, as mentioned earlier, the second sensor unit 14 may be formed by a sensor array. The sensors in the sensor array may be arranged in a way that allows for simultaneous 360° registration of the article 2 from all directions. In addition, sensors may be arranged to enable registration of the top and bottom sides of the article 2.

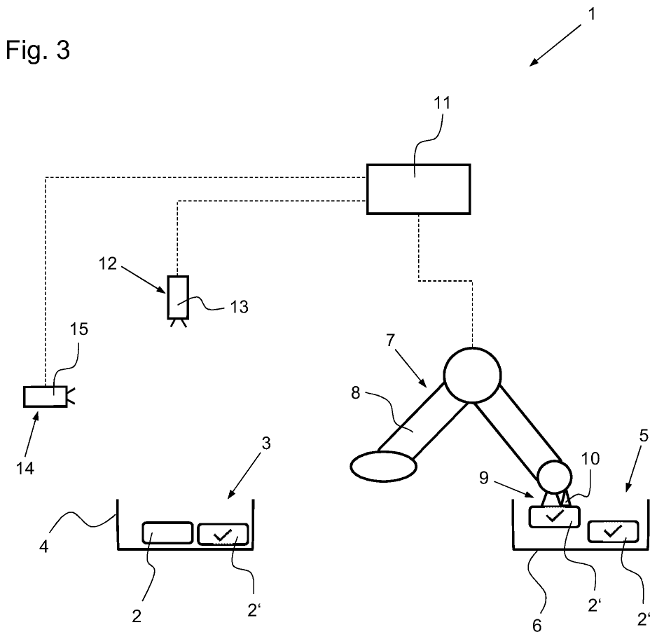

As further illustrated in FIG. 3, after a successful identification of the article 2 at the reading position 16, the control unit 11 controls the handling unit 7 to transport the identified article 2′ to the target position 5 and discharge it there.

For explanation of the other features in FIGS. 2 and 3, reference is made to the above description of FIG. 1.

If the article 2 could not be identified at the reading position 16, the handling unit 7 is controlled by the control unit 11 to return or throw back the article 2 to the source position 3. This may particularly be the case when the identification information is located in the area of the gripping position or gripping surface, respectively, of the article 2 and is therefore covered by the gripping tool 9. The control unit 11 preferably controls the handling unit 7 in a way such that the article 2 at the source position 3 is in a different position and/or orientation than before being picked up by the handling unit 7. In this way, the article 2 may be guided, for example, to tilt or rotate such that the identification information is no longer located in the area of the gripping position or gripping surface, respectively.

For the identification of the articles 2, the control unit 11 may preferably be further configured to use order data. The order data may, for example, be a list of articles 2 of an order that are to be provided at the target position 5. The order data may also already contain the corresponding identification information, thereby contributing to a fast and efficient identification of the articles.

The reading position 16 is, as shown in FIG. 2, preferably located vertically above the source position 3 such that the article 2, if not securely gripped by the handling unit 7, may easily fall back to the source position 3. In addition, if an article 2 is not identifiable or the identification information is unreadable at the reading position 16, respectively, the article 2 may simply be thrown back to the source position 3 since these are directly aligned below each other.

In this way, unnecessary delays due to handling errors or identification failures may be avoided, and there may be provided a system 1 with a significantly higher throughput for the identification and singulation of articles.

The first sensor unit 12 in the system in FIG. 1 according to the first embodiment variant is also configured to register identification information in the area of the gripping position or gripping surface, respectively, of the article 2. In this way, already during the registration of the position and/or orientation of the articles 2, identification information may be read that is located in the gripping position or gripping surface, respectively, of the article 2 and would be covered by the gripping tool 9. In this way, there may be prevented an identification error at the reading position 16 and the throughput of the system may be further increased.

This is schematically indicated in FIG. 2 by the already identified article 2′ at the source position 3, which could be identified in the first step according to FIG. 1 by the first sensor unit 12.

The control unit 11 is further programmed to directly transport a previously identified article 2 to the target position 5 after having it picked up, without first providing it at the reading position 16.

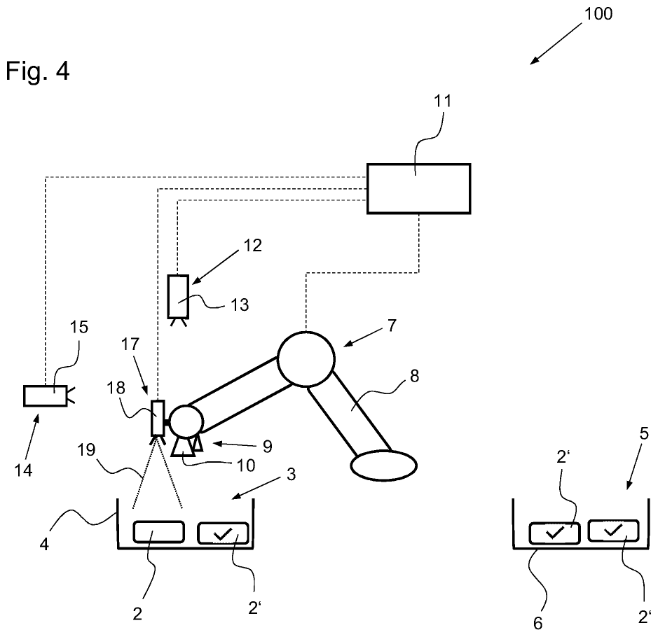

In FIG. 4, there is further illustrated a system 100 according to a second embodiment variant of the invention. The system 100 comprises all features of the system 1 described with reference to FIGS. 1 to 3, with reference being made to the description above.

In addition, the system 100 comprises a third sensor unit 17, which is configured to register identification information in the area of the gripping position or gripping surface, respectively, of the article 2. The third sensor unit 17 is preferably provided on the handling unit and alignable to register the identification information at the gripping position or gripping surface, respectively, of the respective article 2. The third sensor unit 17 may preferably be configured as a camera 18 with a fixed focal length lens, which has a predefined field of view 19. In an alternative embodiment variant, the camera 18 may also have a lens with variable focal length.

The control unit 11 is further configured to register identification information in the area of the gripping position or gripping surface, respectively, of the article 2 using the third sensor unit 17 after determining a gripping position or gripping surface, respectively, for the handling unit 7 and before picking up the article 2, and to identify the article 2 based on the identification information. After successful identification of the article 2, the control unit is further configured to directly transport it to the target position 5 without providing it at the reading position 16 for identification beforehand.

As shown in FIG. 4, the third sensor unit 17 is aligned to a selected article 2 after the position and/or orientation of the articles 2 have been registered by the first sensor unit 12 and after a gripping position or gripping surface, respectively, for the handling unit 7 have been determined. In order to bring the article 2 completely into the field of view 19 of the camera 18, the control unit 11 is further configured to control the handling unit 7 to set the desired distance between the camera 18 and the article 2 and to restrict the field of view 19 of the sensor unit 17 to an evaluation area that corresponds to the article to be gripped at the gripping position or gripping surface, respectively, such that no other articles are located within the evaluation area. Controlling the distance may take into account the registered position and/or orientation of the articles 2, wherein the control unit 11 may preferably be configured to calculate the distance from the position and/or orientation of the articles 2 to restrict the evaluation area accordingly.

The control unit 11 may further be configured to assign the position and/or orientation of the articles 2 registered by the first sensor unit 12 to the identification information of the articles 2 registered by the third sensor unit 17. This assignment may be stored in a memory of the control unit 11 and be taken into consideration when the handling unit 7 picks up articles 2. Thus, the control unit 11 may be further configured to control the handling unit 7 to pick up already identified articles 2, which are provided for direct discharge to the target position 5.

Through the features described above, the throughput of the system 100 may be further increased, such that there may be realized an efficient singulation and identification of articles 2.

FIG. 4 shows, as previously described, a first state of the system 100, wherein the third sensor unit 17 is aligned to a selected article 2 with its field of view 19 for registration of the identification information.

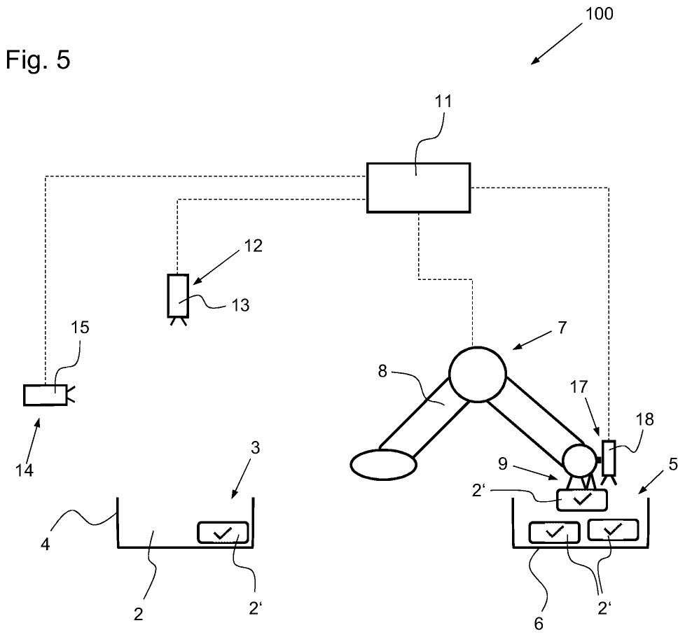

FIG. 5 shows a second state of the system 100 after successful identification of the article. The article 2 does not need to be provided at the reading position 16 of the second sensor unit 14, but may rather be directly discharged to the target position.

For an explanation of the other features in FIGS. 4 and 5, reference is made to the above description of FIG. 1.

1. A system for singulating and identifying articles, comprising:
a handling unit configured to pick up respectively one article from a source position, transporting the article to a target position, and discharging the article at the target position,
a first sensor unit configured to detect the position and/or orientation of the article at the source position,
a second sensor unit configured to register identification information of the article picked up by the handling unit at a reading position, and
a control unit connected to the first sensor unit and the second sensor unit and configured to control the handling unit,
wherein the control unit is configured to register a gripping position or a gripping surface for the handling unit based on the position and/or orientation of the article at the source position, select a gripping method and/or gripping tool for the handling unit, control the handling unit to pick up the article using a selected gripping method and/or gripping tool, and control the handling unit to move the article picked up to the reading position of the second sensor unit,
wherein the reading position of the second sensor unit is arranged above the source position and the control unit is further configured to identify the article picked up based on the identification information and, after successful identification, and control the handling unit to discharge the article to the target position, and
a third sensor unit configured to register identification information in the area of the gripping position or the gripping surface of the article.

2. The system according to claim 1, wherein the first sensor unit is further configured to register identification information in the area of the gripping position or the gripping surface of the article.

3. (canceled)

4. The system according to claim 1, wherein the third sensor unit is provided on the handling unit and is aligned to register the identification information on the gripping position or the gripping surface.

5. The system according to claim 1, wherein the control unit is further configured to register identification information in the area of the gripping position or the gripping surface of the article using the third sensor unit after having determined the gripping position or the gripping surface for the handling unit and before picking up the article, and to identify the article based on the identification information.

6. The system according to claim 1, wherein the control unit is further configured to determine a distance based on the position and the orientation of the article at the source position for the third sensor unit and to restrict the field of view of the third sensor unit to an evaluation area that corresponds to the article to be gripped at the gripping position or the gripping surface.

7. The system according to claim 1, wherein the control unit is further configured to assign the position and/or the orientation of the articles registered by the first sensor unit to the identification information of the articles registered by the third sensor unit.

8. The system according to claim 1, wherein the control unit is further configured to control the handling unit, after having picked up an identified article, to directly discharge the article to the target position.

9. The system according to claim 1, wherein the control unit is further configured to use order data for the identification of the article.
